(19) United States
(12) Patent Application Publication
(10) Pub. No.: US 2008/0101409 A1
(43) Pub. Date: May 1, 2008

(54) PACKETIZATION

(75) Inventors: Matthew J. West, Salem, OR (US); Paul S. Everest, Albany, OR (US); John G. Apostolopoulos, Palo Alto, CA (US); Susie J. Wee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/553,463

(22) Filed: Oct. 26, 2006

(51) Int. Cl. H04J 3/24

(52) U.S. Cl. 370/473; 514/477

(57) ABSTRACT

A method and apparatus analyze a compressed image code stream to determine logical boundaries of segments and parse the data stream into packets, wherein the packets are configured to reduce a number of partial logical segments in individual packets

### BACKGROUND

Compressed image data may be transmitted in packets. During transmission, some packets may be lost, reducing quality of the image.

### BRIEF DESCRIPTION OF THE DRAWINGS

FIG. 1 is a functional block diagram schematically illustrating a link according to one example embodiment.

FIG. 2 is a schematic illustration of a data stream having segments according to one example embodiment.

FIG. 3 is a schematic illustration of one embodiment of a packetization method applied to the segments of FIG. 2 according to an example embodiment.

FIG. 4 is a schematic illustration of a data stream having segments according to one example embodiment.

FIG. 5 is a schematic illustration of one embodiment of a packetization method applied to the segments of FIG. 4 according to an example embodiment.

FIG. 6 is a schematic illustration of a data stream having segments according to one example embodiment.

FIG. 7 is a schematic illustration of one embodiment of a packetization method applied to the segments of FIG. 6 according to an example embodiment.

FIG. 8 is a schematic illustration of a data stream having segments according to one example embodiment.

FIG. 9 is a schematic illustration of one embodiment of a packetization method applied to the segments of FIG. 8 according to an example embodiment.

### DETAILED DESCRIPTION OF THE EXAMPLE EMBODIMENTS

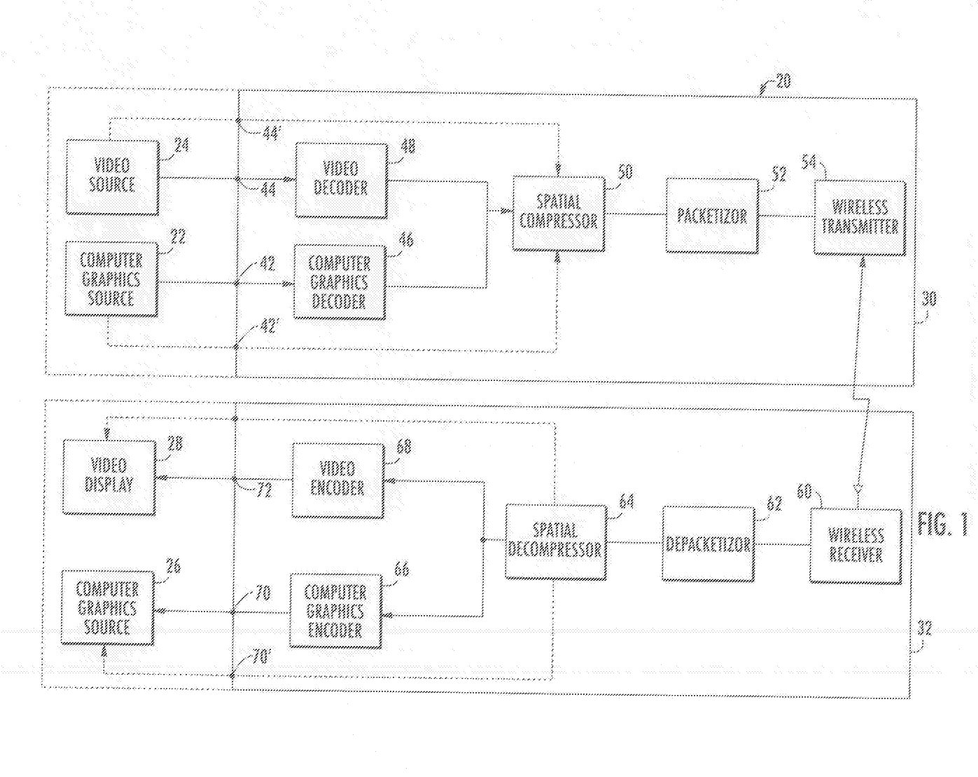

FIG. 1 is a functional block diagram schematically illustrating an image transmitting and receiving system or link 20. Link 20 is configured to transmit one or more streams of compressed image data across a distance from an image source 22, 24 to an image display 26, 28 in a manner so as to enhance the quality of the reconstructed image produced from the image data streams. In particular embodiments, the image data stream may additionally include audio date. For purposes of this disclosure, the term “image data” shall at least include, but not be limited to, computer graphics data such as provided by a computer graphics source 22 (for example, a desktop or laptop computer) and video graphics data, such as provided by a video graphics source 24 (for example, digital versatile disc (DVD) player, Blue-Ray disc player, other disc player or VCR). The transmitted computer graphics data is displayed on a computer graphics display 26 while the transmitted video graphics data is displayed on a video graphics display 28. Examples of a computer graphics display or a video graphics display, include, but are not limited to, a projection system or a flat-panel display. In the particular embodiment illustrated, link 20 is configured to transmit both computer graphics data and video graphics data. In other embodiments, link 20 may alternatively be configured to transmit one of either computer graphics data or video graphics data. In still other embodiments, link 20 may be configured to transmit other forms of image data.

In the example illustrated, link 20 is configured to transmit the streams of compressed image data in a lossy environment. A lossy environment is a wireless or non-quality of service (QoS) wired protocol which may be prone to lost data. The lost data directly contributes to image quality degradation, which results, for example, in the displayed image flickering or including undesired video artifacts, rendering the video product unacceptable to viewers. In low-latency video applications, such degradation is exacerbated when the data is compressed into transmission packets to permit transmission in a real-time lossy-link environment having bandwidth constraints because each packet containing compressed data is used for decoding a large amount of imagery. Depending on the particular compression technique that is used, significant image quality degradation may occur when a single transmission packet is lost. As will be described hereafter, link 20 includes components, devices or one or more processing units that analyze the compressed data stream to determine logical boundaries of segments and selectively parse the data stream into packets in a manner so as to reduce a number of partial logical segments in individual packets. As a result, link 20 reduces the impact of a lost packet to enhance image quality in a lossy transmission environment.

As shown by FIG. 1, link 20 generally includes transmitter module 30 and receiver module 32. Transmitter module 30 and receiver module 32 include one or more processing units by which computer graphics data or video data is manipulated before and after transmission. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments hard wired circuitry may be used in place of or in combination with software instructions to implement the functions described. For example, such processing units may be embodied as part of one or more application-specific integrated circuits (ASICs). Unless otherwise specifically noted, the functional blocks of module 30 or module 32 all are not limited to any specific combination of hardware circuitry and software, nor to any particular source for the instructions executed by a single processing unit incorporating each of the blocks or by multiple processing units incorporating one or more of the functional blocks.

Transmitter module 30 is configured to transmit streams of image data to receiver module 32. In the example illustrated, transmitter module 30 and receiver module 32 form a wireless real-time high-resolution image link. In the example illustrated, transmitter module 30 and receiver module 32 provide a high-speed radio link, data compression, with low end-to-end delay via spatial compression methods and little or no data buffering.

Transmitter module 30 includes input interfaces or ports 42, 44, computer graphics decoder 46, video decoder 48, spatial compressor 50, packetizer 52 and transmitter 54. Input interface or ports 42 connects graphics source 22 to graphics decoder 46 of module 30. In one embodiment, input port 42 may comprise a wired presently available connector, such as, but not limited to, a Video Electronics Standards Association (VESA) 15-pin d-sub, Digital Video Interface (DVI), or DisplayPort connector. In such an embodiment, incoming computer graphics data is first decoded into an uncompressed digital computer graphics data by computer graphics decoder 46. Computer graphics decoder 46 may comprises a presently available hardware decoder, such as an AD9887A decoder device from Analog Devices of Norwood, Mass. In other embodiments, input port 42 and decoder 46 may comprise other presently available or future developed devices or may have other configurations.

Input port 44 connects video graphics source 24 to decoder 48 of module 30. In one embodiment, port 44 is wired to a presently available connector, such as, but not limited to, a composite video connector, component video connector, Super-Video (S-Video connector, Digital Video Interface (DVI) connector, High-definition Multimedia Interface (HDMI) connector or SCART connector. In such an embodiment, incoming video graphics data is first decoded into an uncompressed digital video data by computer graphics decoder 48. Video decoder 48 may comprise a presently available hardware decoder, such as an ADV7400A decoder device for an analog input from Analog Devices of Norwood, Mass. or a Sil9011 decoder device for DVI/HDMI inputs from Silicon Image of Sunnyvale, Calif. In other embodiments, input port 44 and decoder 48 may comprise other presently available or future developed devices or may have other configurations.

As indicated by broken lines, in other embodiments, transmitter module 30 may be embedded with one or both of computer graphics source 22 or video source 24. In those embodiment in which module 30 is embedded with computer graphics source 22, input port 42 may be replaced with a presently available digital interface 42′ such as a 24-bit or a 30-bit parallel data bus which provides uncompressed digital computer graphics data directly to spatial compressor 50. In such an embodiment, computer graphics decoder 46 may be omitted.

In those embodiments in which module 30 is embedded with video source 24, input port 44 may be replaced with an interface 44′ configured to transmit a presently available digital video format, such as an ITU-R BT.601, or ITU-R BT.656 format which provides uncompressed digital video data directly to spatial compressor 50. Examples of other formats include, but are not limited to 480i, 576i, 720p, 1080i and 1080p. In such an embodiment, video decoder 48 may be omitted. In other embodiments, interface 42′ and 44′ may comprise other presently available or future developed interfaces.

Spatial compressor 50 comprises a presently available or future developed device or component configured to compress the digital computer graphics data or the video data using a presently available or future developed spatial data compression algorithm. In one embodiment, spatial compressor 50 utilizes a JPEG 2000 wavelet compression algorithm as supplied by LuraTech, Inc. of San Jose, Calif. Spatial compressor 50 operates on a full frame of incoming data, one field at a time, to minimize delay to one field of video data or one frame of computer graphics data. As a result, the output of spatial compressor 50 is sequential frames of compressed computer graphics data or fields of compressed video data.

Packetizer 52 comprises one or more devices, electronic components or processing units configured to create smaller information units out of the compressed data. Such smaller units may comprise, for example, commands, data, status information and other information, from each frame of compressed data, which is of a larger size (10,000 bytes). As will be described in more detail hereafter, packetizer 52 analyzes the compressed data stream to determine logical boundaries of segments and selectively parses the data steam into packets in a manner so as to reduce an number of partial logical segments in individual packets. Such smaller information units are packets of data passed as synchronous transfers to transmitter 54.

Transmitter 54 is a component, device or one or more processing units configured to transmit compressed and packetized data from module 30 to module 32 in a lossy environment. According to the example embodiment illustrated, transmitter 54 is configured to transmit the compressed and packetized data wirelessly to module 32. In one embodiment, transmitter 54 is a unit wideband (UWB) radio transmitter. In such an embodiment, the UWB radio transmitter has a transmission range of up to, for example, but not limited to, 30 feet. The data rate of transmitter 54 may be in the range of, for example, but not limited to, 110 to 480 Mbps. In such an embodiment, transmitter 54 operates across a relatively large range of frequency bands (for example, 3.1 to 10.6 GHz) with negligible interference to existing systems using same spectrum.

Receiver module 32 receives the compressed and packetized stream of data from transmitter module 30 and manipulates or converts such data for use by either computer graphics display 26 or video display 28. Receiver module 32 includes receiver 60, depacketizer 62, spatial decompressor 64, computer graphics encoder 66, video encoder 68 and output interfaces or ports 70, 72. Receiver 60 comprises a component, device or other structure configured to receive the stream of compressed packetized data from module 30. In the particular example embodiment illustrated in which transmitter 54 is a wireless transmitter, receiver 60 is a wireless receiver. In the example embodiment illustrated, receiver 60 is an ultra wideband radio receiver configured to cooperate with transmitter 54 to receive the stream of data. In other embodiments, receiver 60 may have other configurations depending upon the configuration of transmitter 54. In still other embodiments, where data is transmitted from module 30 to receiver module 32 via electrical signals or optical signals through physical lines, transmitter 54 and receiver 60 may have other configurations or may be omitted.

Depacketizer 62 is a processing unit or a portion of a processing unit configured to receiver the compressed and packetized data from receiver 60 and to reconstruct the compressed packetized data into compressed frames of computer graphics data or video data. During such reconstruction, depacketizer 62 detects and resolves any errors in the incoming packet data. For example, depacketizer 62 detects and handles any packets that have been received twice and disposes of the redundant packets. In one embodiment, depacketizer 62 further detects and any lost packets and replaces the loss of data with, for example, zeroes or data from a previous frame the compressed digital computer graphics data are the compressed digital video data is fed to spatial decompressor 64.

Spatial decompressor 64 comprises a presently available or future developed device, component or processing unit configured to decompress the digital computer graphics data or the video data using a presently available or future developed spatial data decompression algorithm. In one embodiment, spatial compressor 64 utilizes a JPEG 2000 wavelet decompression algorithm as supplied by LuraTech, Inc. of San Jose, Calif. The stream of decompressed computer graphics data or video data are subsequently transmitted to computer graphics encoder 66 and the video encoder 68, respectively, or directly to computer graphics display 26 or video display 28.

Computer graphics encoder 66 encodes the outgoing computer graphics data into a format suitable for transmission over output port 70. In one embodiment encoder 66 is a presently available or future developed hardware encoder. Examples of a presently available computer graphics encoder include, but are not limited to, the Sil164 encoder device for a DVI output from Silicon Image of Sunnyvale, Calif. or the ADV7122 encoder device for analog output from Analog Devices of Norwood, Mass. In such an embodiment, output port 70 may comprise a wired presently available or future developed connector. Examples of such a presently available connector include, but are not limited to, a VESA 15-pin d-sub, DVI, or DisplayPort connector. In other embodiments, other encoders and connectors may be utilized.

Video graphics encoder 68 encodes the outgoing computer graphics data into a format suitable for transmission over output port 72. In one embodiment encoder 68 is a presently available or future developed hardware encoder. Examples of a presently available hardware encoder include, but are not limited to, Sil9190 encoder device for DVI/HDMI output from Silicon Image of Sunnyvale, Calif. or the ADV7320 encoder device for an analog output from Analog Devices of Norwood Mass. In such an embodiment, output port 72 is a wired presently available connector, such as, but not limited to, a composite video connector, a component video connector, an S-video connector, DVI connector, HDMI connector or SCART connector. In yet other embodiments, other encoders and connectors may be utilized.

As indicated by broken line, in other embodiments, receiver module 32 may be incorporated as part of or embedded with one or bother of computer graphics display 26 or video display 28. In such an embodiment, the compressed image data may be transmitted directly from spatial decompressor 64 to one or both of display 26 or display 28, enabling one or both of encoder 66 or encoder 68 to be omitted. In those embodiments in which module 32 is embedded with display 26, port 70 may be replaced with port 70′ which may comprise a presently available 24 bit or 30 bit parallel data bus. In those embodiments in which module 32 is embedded with display 28, port 72 may be replaces with port 72′ which may comprise a presently available digital interface such as an ITU-R BT.601 or IU-R BT.656 format. Examples of other formats include, but are not limited to, 480i, 576i, 480p, 720p, 1080i and 1080p. In other embodiments, ports 70′ and 72′ may have other configurations.

Although Link 20 has been illustrated as having each of the aforementioned functional blocks as provided by one or more processing units and electronic componentry, in other embodiments, Link 20 may be provided by other arrangements. Although Link 20 has been described as having a single transmitter module 30 and a single receiver module 32, in other embodiments. Link 20 may alternatively include a single transmitter module 30 and multiple receiver modules 32, multiple transmitter modules 30 in a single receiver module 32 are multiple transmitter modules 30 and multiple receiver modules 32.

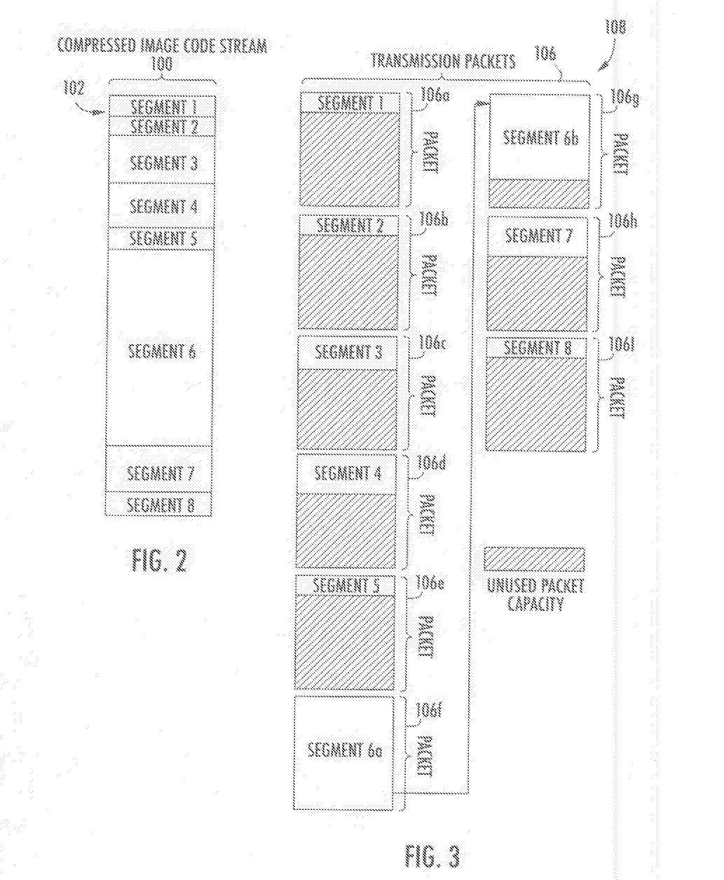

FIGS. 2 and 3 schematically illustrate one method by which packetizer 52 may analyze a compressed data stream to determine logical boundaries of segments and parse the data stream into packets, wherein the packets are configured to reduce a number of partial logical segments in individual packets. In particular, FIG. 3 schematically illustrates a packetization method 108 utilizing strict segregation. In the example illustrated, the strict segregation of segments 102 illustrated in FIG. 3 is in any non-QoS application. A QoS application is one where transmission rates, error rates and other characteristics are guaranteed in advance.

FIG. 2 illustrates a compressed image code or data stream 100 received by packetizer 52 from spatial compressor 50 (shown in FIG. 1). In one embodiment, stream 100 includes data compressed by a JPEG 2000 wavelet compression algorithm as supplied by Lura Tech, Inc. of San Jose, Calif. In other embodiments, the compressed steam 100 may be compressed using other techniques or algorithms. As further shown by FIG. 2, packetizer 52 analyzes steam 100 to determine logical image segments 102 individually referred to as segment 1, segment 2, segment 3, segment 4, segment 5, segment 6, segment 7 and segment 8. Segments 102 include information on the entire code or data stream 100, add-on information of how a decompression function must handle the data, information pertaining to different regions of the image, information about resolution layers, information about security and so on. Segments 102 have an arbitrary size which is dependent upon a quantity of data contained within each segment. Each segment 106 may contain different pieces of information having different levels of importance relative to the quality of the image to be displayed. According to one embodiment, packetizer 52 determines logical boundaries of segments 102 by analyzing header information of stream 100. For example, in many file formats, a length of each logical boundary for segments 102 is noted in a file header located at the beginning of each logical segment. In other embodiments, the determination logical boundaries of segments 102 of stream 100 may be determined in other fashions or may be provided to packetizer 52.

According to one example embodiment, data stream 100 is compressed using a JPEG 2000 wavelet-based compression format. In such an embodiment, packetizer 52 may identify segment boundaries as those boundaries between information “layers”. Each information layer has sufficient data to form a complete image having a selected degree of quality or resolution. The quality or resolution of the display image will increase as more “layers” are transmitted and received. Partial “layers”, layers for which data was lost during transmission, may not be usable. In such an embodiment, packetizer 52 identifies the segment boundaries as those boundaries between such layers in the stream 100 of data being transmitted such that segments 102 each comprise one or more substantially complete layers of the compressed image. Although FIG. 2 illustrates data stream 100 divided into eight segments 102, in other embodiments, packetizer 52 may determine that data stream 100 should be divided into greater or fewer of such segments 102. Based upon the determined boundaries of such logical segments, packetizer 52 further parses data stream 100 into packets 106 as shown by FIG. 3.

FIG. 3 illustrates one method 108 by which packetizer 52 divides or parses segments 102 amongst packets 106. In particular, FIG. 3 illustrates segments 102 divided amongst nine sequential transmissions packets 106A, 106B, 106C, 106D, 106E, 106F, 106G, 106H and 106I. Packets 106 have a predetermined equal size. In one embodiment, packets 106 may each have a size of 188 bytes. In other embodiments, packets 106 may have other sizes. According to the method shown in FIG. 3, segments 102 are split amongst packets 106 such that no two segments 102 are contained in a single transmission packet 106. In other words, each transmission packet 106 contains one segment 102 only for strict segregation of logical segments 102.

As illustrated with packets 106F and 106G, in those circumstances where a segment 102 has a size that is greater than the size of a transmission packet 106, the particular segment is split across multiple transmission packets 106 with any remaining transmission packet capacity of the last packet 106 being unused. In the example illustrated, segment 6 is larger than the size of each of packets 106 such that segment 6 is split into segment portions 6a and 6b which are transmitted in packets 106F and 106G, respectively. That portion of packet 106G not taken up by segment portion 6b remains unused.

The packetization method illustrated by FIGS. 2 and 3 and carried out by packetizer 52 (shown in FIG. 1) minimizes degradation of visual image quality resulting from the lost of one or more packets 106 in a lossy environment. In particular, the loss of any one packet 106 that has a logical segment 102 contained therein does not result in a loss of a neighboring logical segment 102 in a subsequent packet 106 since no logical segment is allowed to be appended to another segment within the same transmission packet 106. Thus, the loss of the given packet 106 results in the loss of one segment 102. In the case of packets 106F and 106G, the loss of either packet results in the loss of segment 6, wherein neighboring logical segment 7 in subsequent packet 106H is not lost.

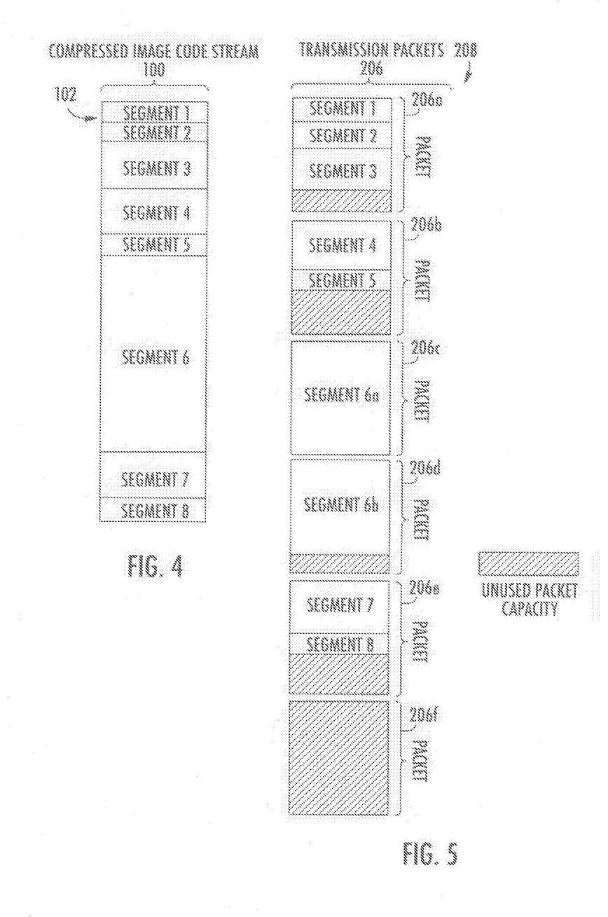

FIGS. 4 and 5 schematically illustrate another method by which packetizer 52 (shown in FIG. 1) may analyze a compressed data stream to determine logical boundaries of segments and parse the data stream into packets, wherein the packets are configured to reduce a number of partial logical segments in individual packets. In particular, FIG. 5 schematically illustrates a packetization method 208 providing for complete containment of segments 102 of compressed data. As with the method described in FIGS. 2 and 3, the method described with FIGS. 4 and 5 relates to a non-QoS application.

FIG. 5 illustrates packetization method 208 being applied to the same set of logical segments 102 of code or data stream 100 that is once again shown in FIG. 4 and that is described above with respect to FIG. 2. As shown by FIG. 4, packetizer 52 (shown in FIG. 1) divides or parses segments 102 amongst six sequential transmission packets 206A, 206B, 206C, 206D, 206E and 206F (collectively referred to as packets 106). Packets 206 have a predetermined equal size. In one embodiment, packets 206 may each have a size of 188 bytes. In other embodiments, packets 206 may have other sizes.

According to the method 208 shown in FIG. 5, segments 102 are split amongst packets 206 such that one or more segments 102 are contained in a single transmission packet 206 if and only if an entirety of each logical segment 102 is contained within the single packet. In other words, each transmission packet 206 contains one or more segments 102 in their entirety and no partial segments 102 are allowed to be included along with neighboring segments 102 in the same transmission packet 206. In the example illustrated, segments 1-3 are contiguously appended to one another and entirely contained within packet 206A, segments 4 and 5 are contiguously appended to one another and entirely contained within packet 206B and segments 7 and 8 are contiguously appended to one another and entirely contained within packet 206E.

As illustrated with packets 206C and 206D, in those circumstances where a segment 102 has a size that is greater than the size of a transmission packet 206, the particular segment is split across multiple transmission packets 206 with any remaining transmission packet capacity of the last packet 206 being unused. In the example illustrated, segment 6 is larger than the size of each of packets 206 such that segment 6 is split into segment portions 6a and 6b which are transmitted in packets 206C and 206D, respectively. The full capacity of packets 206C is utilized while that portion of packet 206D not taken up by segment portion 6b remains unused.

As with the packetization method 108 shown in FIG. 3, packetization method 208 minimizes degradation of visual image quality resulting from the loss of one or more packets 106 in a lossy environment. In particular, the loss of any one packet 206 that has one or more logical segments 102 contained therein does not result in a loss of neighboring logical segments 102 that are contained in subsequent packets 206 since any segment or combination of segments 102 that are smaller than a transmission packet 206 are completely contained in a single packet 206 and are not allowed to cross boundaries of packets 206. Thus, the loss of a given packet 206 results in the loss of one or more complete segments 102 without affecting neighboring segments 102 of subsequent packets 206.

As shown by FIG. 5, because multiple segments 102 may be contained within a single packet 206 with method 208, the amount of unused transmission packet capacity may be reduced as compared to method 108. For example, method 208 does not utilize packet 206F. As a result, packet 206F may be used to contain one or more segments 102 following segment 8 of stream 100.

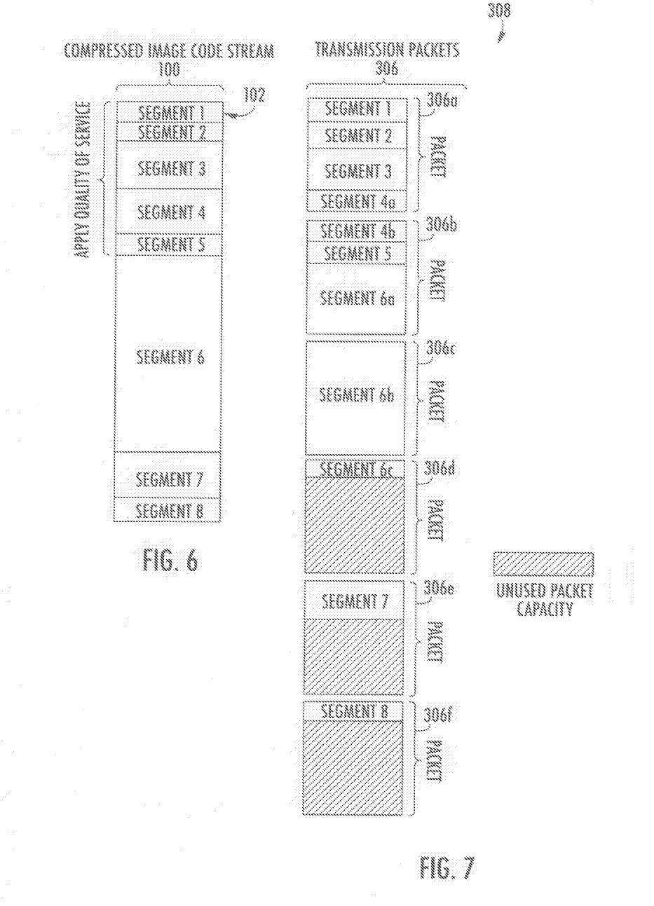

FIGS. 6 and 7 schematically illustrate another method by which packetizer 52 (shown in FIG. 1) may analyze a compressed data stream to determine logical boundaries of segments and parse the data stream into packets, wherein the packets are configured to reduce a number of partial logical segments in individual packets. In particular. FIG. 7 schematically illustrates a packetization method 308 for managing multiple segments 102 of compressed data to which varying levels of QoS are applied. FIG. 6 schematically illustrates the same compressed image code or data stream 100 and the same segments 102 as described above in FIG. 2 except the FIG. 6 further illustrates a QoS applied to segments 1-5 while QoS is not applied to segments 6, 7 and 8. In the example illustrated, the QOS application to segments 1-5 means that such segment are designated with a greater priority among transmitted traffic, improving performance, throughput, or latency in order to reduce the likelihood that such logical segments will be lost during transmission. Examples of increased priority might include; retries or retransmissions; duplicate sending; and greater bandwidth or speed.

As shown by FIG. 7, method 308 parses segments 1-8 taking into account the QoS designation applied to segments 1-5. In particular, QoS designated segments 1-5 are permitted to be contiguously appended to one another and to be split between consecutive packers 306 since there is a reduced likelihood of such segments being lost. Non-QoS segments 6-8 are divided and parsed amongst packets using either the strict segregation method 108 as described above with respect to FIG. 3 or the complete containment method 308 as described above with respect to FIG. 7. In method 308, non-QoS designated segments may optionally be split amongst multiple packets 306 where one of the packets 306 containing the split non-QoS designated segment also contains a QoS designated segment.

In the example illustrated, QoS designated segments 1-3 are completely contained within packet 306A. QoS designated segment 4 is split into segment portion 4a which is contained within packet 306A and segment portion 4b which is contained within packet 306B along with QoS designated segment 5. Non-QoS designated segment 6, being larger than the size of packets 306, is split amongst packets 306B, 306C and 306D. Segment 6 is split into segment portion 6a which is appended to QoS designated segments 4 and 5 in packet 306B. Segment portion 6a fully utilizes the capacity of packet 306C. The remaining segment portion 6c is placed into packet 306D. In the example illustrated in FIG. 7, segment portion 6c and non-QoS designated segments 7 and 8 are strictly segregated in packets 306D, 306E and 307F, respectively. In other words, each of transmission packets 306D, 306E and 306F each contain only a single non-QoS designated pacts or packet portion. Alternatively, using the complete containment method 208 (See FIG. 5), segments 7 and 8 may be combined in to a single packet 306E if both of such segments may be completely contained within packet 306E, permitting packet 306F to contain an additional segment or segments.

As with the packetization methods 108 and 208, packetization method 308 minimizes degradation of visual image quality resulting from the loss of one or more packets 306 in a lossy environment. In particular, the loss of any one packet 306 that has one or more logical segments 102 contained therein does not result in a loss of neighboring logical segments 102 that are contained in subsequent packets 306 since any segment or combination of segments 102 that are smaller than a transmission packet 306 are completely contained in a single packet 306 and is not allowed to cross boundaries of packets 306 unless appended to a QoS designated segment where the particular segment 102 is larger than the packet size. Thus, the loss of a given packet 306 results in the loss of one or more complete segments 102 without affecting neighboring segments 102 of subsequent packets 306.

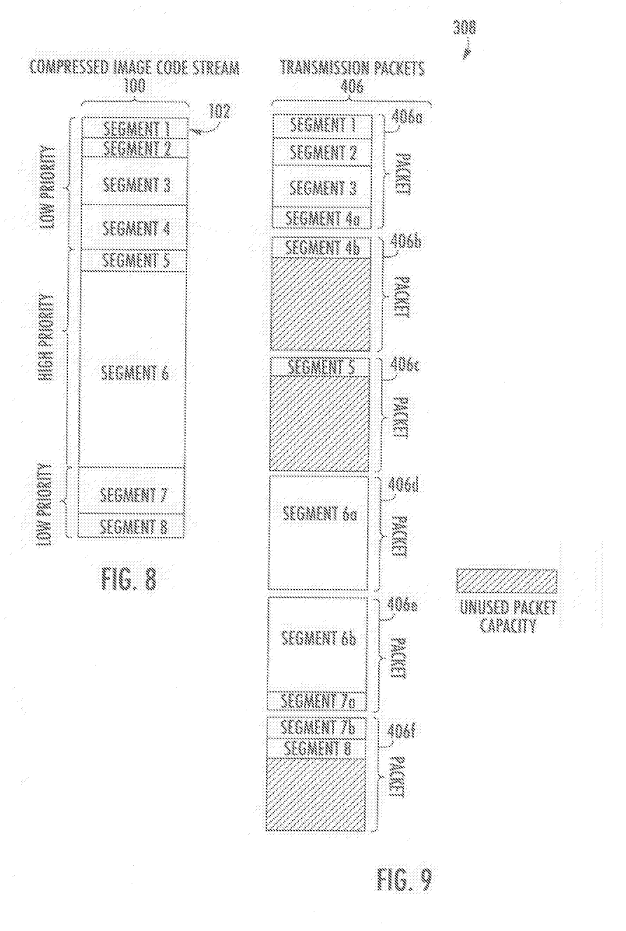

FIGS. 8 and 9 schematically illustrate another method by which packetizer 52 (shown in FIG. 1) may analyze a compressed data stream to determine logical boundaries of segments and parse the data stream into packets, wherein the packets are configured to reduce a number of partial logical segments in individual 408 for managing multiple segments 102 of compressed data to which varying levels of prioritization are applied. FIG. 8 schematically illustrates the same compressed image code or data stream 100 and the same segments 102 as described above in FIG. 2 except that FIG. 8 further illustrates a priority designation applied to segments 1-8. Whether a particular segment 102 is given a high priority or a low priority may be based upon several factors, including, but not limited to, a particular segment's contribution to image quality. In the example illustrated, segments 1-4 and 7-8 are given or are designated with a low priority while segments 5 and 6 are given or are designated with a higher priority. In other embodiments, the priority given to each segment 102 may be based upon other additional or alternative factors.

As shown by FIG. 9, method 408 parses segments 1-8 taking into account the priority designation applied to segments 1-8. In particular, low priority designated segments are permitted to be contiguously appended to one another or to high priority segments. Low priority designated segments are further permitted to be split between consecutive packets 306 since their loss or partial transmission has been determined to have a lesser impact upon the quality of final reconstructed image. In contrast, high priority designated segments are either strictly segregated per method 108 as described above with respect to FIG. 5. Segments 5-6 are divided and parsed amongst packets using either the strict segregation method 108 as described above with respect to FIG. 3 or the complete containment method 208 are applied to high priority segments, degradation of the reconstructed image quality upon the loss of any given transmission packet 406 are minimized.

In the example illustrated, low priority segments 1-3 are contiguously appended to one another and entirely contained within packet 406A. Because segment 4 is a low priority segment and because segment 4 cannot be “fit” within the remaining unused capacity of packet 406A, segment 4 is split into segment portions 4a and 4b. Segment portion 4a is contained within packet 406A while segment portions 4b is contained within the next success of transmission packet 406B. Since segment 5 is a high priority segment and since the strict segregation method 108 is being applied to such high priority segment, segment 5 is not appended to segment portion 4b in transmission packet 406B, but is placed in transmission packet 406B by itself. Alternatively, if the complete containment method 208 was applied to high priority segments, segment 5 would be contiguously appended to low priority segment portion 4b within transmission packet 406B since segment 5 could be completely contained within packet 406B with segment portion 4b.

As illustrated with packets 406D and 406E, in those circumstances where a segment 102 has a size that is greater than the size of a transmission packet 406, the particular segment is split across multiple transmission packets 406 with any remaining transmission packet capacity of the last packet 406 being unused. In the example illustrated, segment 6 is larger than the size of each of packets 406 such that segment 6 is split into segment portions 6a and 6b which are transmitted in packets 406D and 406E, respectively. Since the next successive segment, segment 7, is a low priority segment, segment 7 may be split. As a result, the remaining unused capacity of packet 406E is used to contain segment portion 7a of segment 7. The remainder of segment 7, segment portion 7b, is placed within packet 406F with low priority segment 8.

Overall, methods 108, 208, 308 and 408 shown and described with respect to FIGS. 3, 5, 7 and 9, respectively, packetize image code or data stream 100 based upon segment lengths to minimize or eliminate unwanted partial logical segments in a single transmission packet. As a result, degradation of the quality of the reconstructed image upon the loss of one or more packets is reduced. As described above, in some cases, it is acceptable and desirable to have multiple logical boundaries contained in a single transmission packet such as when multiple logical segments are completely contained in one transmission packet, a low-overhead QoS method is employed or the content of the logical segment is deemed of lower priority. Such special cases better utilize available limited bandwidth by minimizing unused transmission packet capacity.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
analyzing a compressed data stream to determine logical boundaries of segments; and
parsing the data stream into packets, wherein the packets are configured to reduce a number of partial logical segments in individual packets.

2. The method of claim 1, wherein the method is carried out in a real-time lossy transmission environment.

3. The method of claim 1, wherein the compressed data stream comprises a wavelet-based compression code-stream format.

4. The method of claim 3, wherein compressed data stream comprises JPEG 2000.

5. The method of claim 1, wherein the packets are configured such that each segment is solely contained in a packet.

6. The method of claim 1, wherein the packets are configured such that one or more segments are included in a packet if each segment is an entirely contained within the packet.

7. The method of claim 1 further comprising applying varying levels of quality of service (QoS) to different segments, wherein the packets are configured such that segments to which is applied a higher level of QoS are split amongst packets and segments to which is applied a lower level of QoS either are each entirely contained in a packet or are solely contained in a packet.

8. The method of claim 1 further comprising prioritizing the logical segments, wherein the packets are configured such that segments having a high priority are solely contained in a packet and segments having a low priority are combined and split amongst packets.

9. The method of claim 8, wherein the logical segments are prioritized based on each segment's contribution to image quality.

10. The method of claim 1 further comprising transmitting the packets wirelessly to a display device.

11. The method of claim 10, wherein the packets are transmitted using an ultra wideband connection.

12. An image transmission device comprising:
one or more processing units configured to:
analyze a compressed data stream to determine logical boundaries of segments; and
parse the data stream into packets, wherein the packets are configured to reduce a number of partial logical segments in individual packets; and
a transmitter configured to wirelessly transmit the packets to at least one image receiving device.

13. The device of claim 12 further comprising a decoder configured to decode video or graphics data into a standardized uncompressed digital video or graphics data.

14. The device of 12, wherein the one or more processing units are configured to spatially compress the digital video or graphics data.

15. The device of claim 12, wherein the spatial compressor operates on a full frame of incoming data, one frame at a time to provide sequential compress video or graphics data.

16. The device of claim 12, wherein the packets are configured such that each segment is solely contained in a packet.

17. The device of claim 12, wherein the packets are configured such that one or more segments are included in a packet if each segment is an entirely contained within the packet.

18. The device of claim 12, wherein the one or more processing units are further configured to apply varying levels of quality of service (QoS) to different segments, wherein the packets are configured such that segments to which is applied a higher level of QoS are split amongst packets and segments to which is applied a lower level of QoS either are each entirely contained in a packet of are solely contained in a packet.

19. The device of claim 12 prioritizing the logical segments, wherein the packets are configured such that segments having a high priority are solely contained in a packet and segments having a low priority are split amongst packets.

20. A computer readable medium comprising instructions directing one or more processing units to:
analyze a data stream to determine logical boundaries of segments; and
parse the data stream into packets, wherein the packets are configured to reduce a number of partial logical segments in individual packets.
